(19) United States
(12) Patent Application Publication
(10) Pub. No.: US 2006/0203048 A1
(43) Pub. Date: Sep. 14, 2006

(54) Plug

(76) Inventors: Joseph E. Scheffelin, Poway, CA (US); Teresa D. Kassen, San Diego, CA (US); Martin A. Kuetzing, San Diego, CA (US); Michael Martin, Newport, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/080,115

(22) Filed: Mar. 14, 2005

(51) Int. Cl. B41J 2/175

(52) U.S. Cl. 347/86

(57) ABSTRACT

One embodiment of a plug includes a multi-lobed plug including a part line positioned within a recess between said multi-lobes.

### BACKGROUND

Fluid dispensers, such as imaging devices, namely, printers, may utilize fluid from a fluid cartridge during use. The fluid cartridge may include ports that extend between an interior of the fluid cartridge and an exterior thereof. The ports may include a fluid fill port, a leak test port, a gas exhaust port, a flush port and the like. During use of the fluid cartridge it may be desirable that these ports be sealed. Accordingly, it may be desirable to provide a plug that is inexpensive to manufacture, provides increased assurance of a good fit, and may be manufactured with a reduced number of processing steps.

### BRIEF DESCRIPTION OF THE DRAWINGS

FIG. 1 is a schematic side partial cross-sectional view of one embodiment of an imaging device including a fluid cartridge therein, with one embodiment of a plug positioned within a port of the fluid cartridge.

FIG. 2 is a schematic side partial cross-section view of one embodiment of a prior art plug positioned within a port.

FIG. 3 is a perspective view of the plug of FIG. 1.

FIG. 4 is a schematic side partial cross-sectional view of the plug of FIG. 1.

FIG. 5 is a schematic side cross-sectional view of one embodiment of a mold used for manufacturing one embodiment of a plug.

### DETAILED DESCRIPTION OF THE DRAWINGS

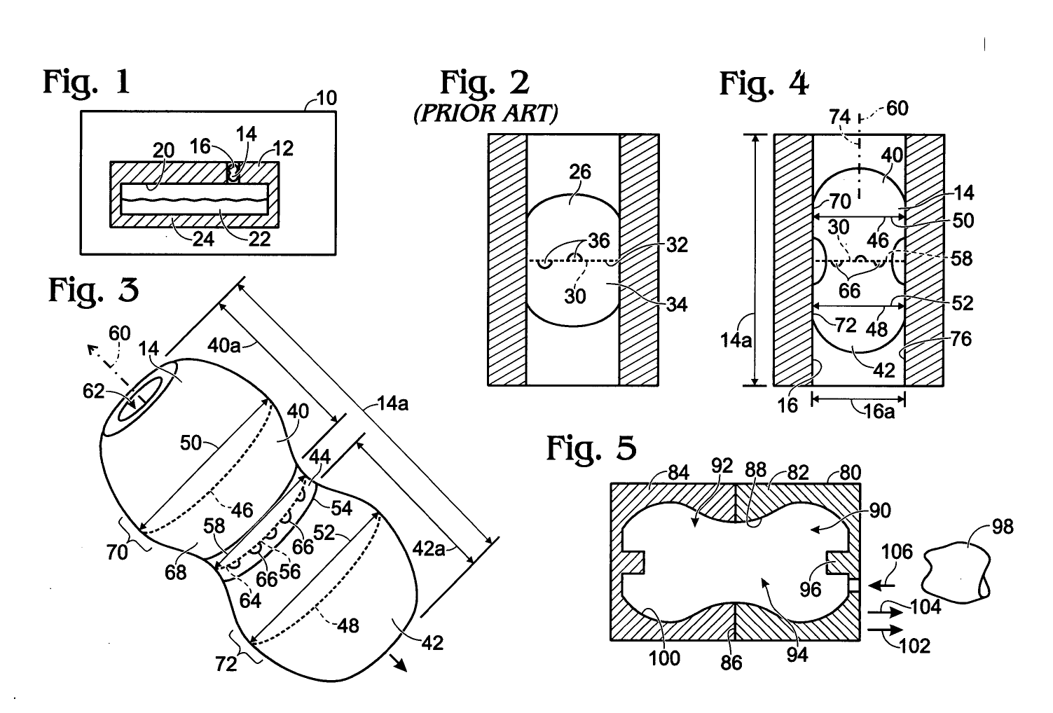

FIG. 1 is a schematic side partial cross-sectional view of one embodiment of an imaging device 10 including a fluid cartridge 12 therein, with one embodiment of a plug 14 positioned within a port 16 of the fluid cartridge 12. In the embodiment shown, fluid cartridge 12 is an ink cartridge and imaging device 10 is a printer. In other embodiments fluid cartridge 12 may be utilized in other applications, such as in a medical device. Fluid cartridge 12 may be manufactured of plastic and plug 14 may be manufactured of a resilient, flexible material such as rubber or the like. Imaging device 10 may print a fluid, such as ink 18, on a print media (not shown) such as a sheet of paper. Fluid cartridge 12 may include an ink chamber 20 that defines an interior 22, wherein port 16 may extend between interior 22 and an exterior 24 of fluid cartridge 12. In other embodiments, fluid cartridge 12 may include a plurality of ink chambers 20 (not shown), such that the different chambers may each include a different ink, such as each including a different color or type of ink 18.

FIG. 2 is a schematic side partial cross-sectional view of one embodiment of a prior art plug 26 positioned within a port 28. Prior art plug 26 may be spherical in shape wherein a partline 30 (indicated in dash lines) of plug 26 is positioned around a diameter 32 of seal 26 and in contact with port 28. (The spherical shape of plug 26 may be slightly compressed by port 28 when the plug is retained therein.) Partline 30 may be generated when two mold halves (not shown) are placed together for molding of plug 26. During the manufacturing process the molten or liquified plug material 34 may seep into small spaces between the two mold halves (not shown) and solidify to form extensions 36, which may also be referred to as flash. When the two mold halves (not shown) are removed from one another, extensions 36 may remain n plug 26. In a spherical plug, partline 30 and extensions 36 may be positioned along a sealing region 38 of the plug, depending on the orientation of plug 26 within port 28. When extensions 36 are positioned within sealing region 38, the extensions may reduce the sealing properties of plug 26.

Accordingly, prior art processes may include additional steps to remove extensions 36, such as grinding, tumbling and the like. Such processes may leave the plug undersized so that the plug may be initially manufactured oversized. Even after such steps, plug 26 may still not define a sufficient seal of port 28. Such over sizing and additional processing steps may increase the manufacturing costs of the plug, may provide a plug having reduced sealing properties in particular orientations, and may increase the time to manufacture the plug.

FIG. 3 is a perspective view of plug 14 of FIG. 1. In this embodiment plug 14 includes a first region 40, a second region 42, and a recessed region 44 positioned therebetween. First and second regions 40 and 42 may be defined as lobed or substantially spherical regions each including a greatest circumference dimension 46 and 48, respectively (indicated in dash lines), which may define a diameter 50 and 52, respectively, of each section 40 and 42. Substantially spherical may be defined as regions 40 and 42 defining a spherical shape within regions 40a and 42a, respectively, which may not include recessed region 44. Recessed region 44 may define a groove 54 having an outside circumference dimension 56 (indicated in dash lines) that defines a diameter 58 that is at least five percent smaller than diameters 50 and/or 52 of each of regions 40 and 42. In one example, each of diameters 50 and 52 of the substantially spherical regions 40 and 42 may be in a range of 3.37 to 3.53 millimeters (mm), and may be approximately 3.45 mm, and diameter 58 of recessed region 44 may be in a range of 2.95 to 3.05 mm, and may be approximately 3.00 mm. Recessed region 44, in general, may referred to as being approximately 5 percent smaller than the outer diameter of spherical regions 40 and 42. Of course, the plug may be sized with any dimensions as suited for a particular application. In the particular embodiment described, port 16 may have an inner diameter 16a (see FIG. 4) of approximately 3.12 mm, such that plug 14 may be compressed at spherical regions 40 and 42 to fit within aperture 16. In other embodiments the multi-lobed plug may have two or more lobes that may be manufactured in any shape or length, such as square, oval, hexagon, or other such shapes, as may be desired for particular applications and particular aperture sizes and shapes in which the plug may be placed.

Plug 14 may define an elongate axis 60 that may extend through plug 14 substantially perpendicular to circumference dimensions 46, 48 and 56, and substantially perpendicular to diameters 50, 52 and 58. Plug 14 may also include a hollow interior, such as a hollow cylindrical cavity 62 that may extend partially along elongate axis 60 of the plug. Hollow cylindrical cavity 62 may allow plug 14 to be readily removed from a mold during manufacturing thereof, and may allow plug 14 to be resiliently inserted into port 16 of a fluid cartridge 12 (see FIG. 1). However, hollow cavity 62 may not extend completely along elongate axis 60 of plug 14 so that the plug forms a solid, air and fluid impermeable seal within port 16.

Plug 14 may further include a partline 64 that may be contiguous with circumference dimension 56 of recessed region 44. Extensions 66 of plug material 68 may extend outwardly from recessed region 44 along partline 64. These extensions 66, or flash, generally do not extend outwardly a distance from partline 64 greater than circumference dimensions 46 and 48 of first and second lobed regions 40 and 42. Accordingly, when plug 14 is positioned within a port 16 (see FIG. 4), extensions 66 may not contact port 16 and may not interfere with sealing regions 70 and 72 of first and second regions 40 and 42 of plug 14.

FIG. 4 is a schematic side partial cross-sectional view of one embodiment of plug 14 positioned within port 16 of FIG. 1. Plug 14 may define a length 14a along elongate axis 60 of plug 14 that may be greater than each of diameters 50, 52 and 58. Port 16 may define an inside diameter 16a that may be slightly smaller than diameters 50 and 52 of first and second lobed regions 40 and 42, respectively, slightly greater than diameter 58 of recessed region 44, and substantially less than length 14a of plug 14. Accordingly, plug 14 may be positioned within port 16 with elongate axis 60 of the plug aligned parallel to an elongate axis 74 of port 16. In this position, sealing regions 70 and 72 of plug 14 may each contact an inner wall 76 of port 16 around circumferences 46 and 48, respectively, of lobed regions 40 and 42. Each of sealing regions 70 and 72 may define a separate seal such that plug 14 may provide a redundant seal of port 16.

Extensions 66 along partline 30 may be positioned within recessed region 44 such that the extensions 66 do not contact sealing inner wall 76 of port 16 and are not positioned within sealing regions 70 or 72 of lobed regions 40 and 42. Accordingly, extensions 66 may not hinder the sealing properties of plug 14. Moreover, positioning of extensions 66 within recessed region 44 may allow manufacturing of plug 14 without additional processing steps to remove the extensions 66, and without manufacturing of plug 14 in an oversized dimension, such that the plug may not be reduced in size after processing to reach a desired size. In other words, plug 14 may be initially manufactured in a desired size without additional processing steps such as grinding or tumbling. Accordingly, plug 14, having a double lobed shape with a partline 30 and extensions 66 recessed from contact with inner sealing surface 76 of port 16, may provide a plug that is inexpensive to manufacture, provides increased assurance of a good fit within a port, and may be manufactured with a reduced number of processing steps.

The double lobed shape of plug 14 may also facilitate placement of the plug 14 within a port 16 with an elongate axis 74 of the plug aligned with an elongate axis 60 of port 16, thereby ensuring proper orientation of plug 14 within port 16. Moreover, either of first or second regions 40 and 42 may initially be inserted into port 16 such that installation of plug 14 may not require an assembly technician to chose which of lobes 40 or 42 will be first inserted into the port.

FIG. 5 is a schematic side cross-sectional view of one embodiment of a mold 80 used for manufacturing one embodiment of a plug 14 (see FIG. 3). Mold 80 may include a first section or half 82 and a second mating section or half 84. Sections 82 and 84 may be placed together along a partline 86 that may form partline 30 of plug 14 (see FIG. 3). Mold 80 may define a cavity 88 that includes a first lobed region 90, a second lobed region 92, and a recessed region 94 positioned therebetween. Mold 80 may also define a central core 96 that may form hollow cavity 62 of plug 14 (see FIG. 3). Mold 80 may be manufactured of a temperature resistant, durable material such as steel or the like, that may be ground to particular and precise dimensions. Mold 80 may further include a highly polished interior mold surface 100. During manufacture of a plug 14, one mold half 82 may remain stationary, and second mold half 84 may be removed from mold half 82 to remove a newly formed plug 14. In particular, movable mold half 84 may be removed in direction 102 and a newly formed plug 14 within mold 80 may be removed in direction 104.

One embodiment of a process of sealing a port 16 with a plug 14 will now be described. First mold half section 82 may be secured to second mold half section 84 such that the mold half sections meet at partline 86. Molten or liquified seal material 98 may then be pulled or drawn through mold 80 in a draw direction 106 until cavity 88 is filled with seal material 98. During this process, seal material 98 may seep between mold section 82 and 84 so as to form extensions 66 or flash (see FIG. 3). The seal material 98 may then be dried or cured to form plug 14. Plug 14 may then be removed from mold 80 (see FIG. 3). Plug 14, without further processing, may then be inserted into port 16 wherein sealing region 70 and 72 may each define a separate seal with the inner wall 76 of the port 16 (see FIG. 4).

Other variations and modifications of the concepts described herein may be utilized and fall within the scope of the claims below.

We claim:

1. A plug, comprising:
a multi-lobed plug including a part line positioned within a recess between said multi-lobes.

2. The plug of claim 1 wherein said recess defines a non-sealing region of said plug.

3. The plug of claim 1 wherein said multi-lobed plug defines a double sphered plug, wherein said each of said spheres define a diameter and wherein said recess defines a diameter at least 5% smaller than said diameter of each of said double spheres.

4. The plug of claim 3 wherein said diameter of each of said double spheres defines a sealing region of each of said double spheres.

5. The plug of claim 1 wherein said plug is manufactured of a resilient, flexible material.

6. The plug of claim 1 further includes an elongate axis positioned substantially perpendicular to said part line and at least one mold draw positioned on an end of said plug along said elongate axis.

7. The plug of claim 6 wherein said plug includes hollow regions along said elongate axis.

8. The plug of claim 1 wherein said plug includes flash positioned along said partline, said flash extending outwardly from said partline to a distance less than a greatest outside perimeter of said plug.

9. A print cartridge comprising:
a body that defines an interior;
an aperture that extends through said body between said interior and an exterior thereof; and
a plug positioned within said aperture and including a first lobe, a second lobe and a groove positioned therebetween, said first and second lobes each defining a sealing region against said aperture and said groove positioned outside said sealing regions.

10. The print cartridge of claim 9 wherein said plug is positioned within a substantially cylindrically shaped section of said aperture.

11. The print cartridge of claim 9 wherein said plug includes a partline positioned within said groove.

12. The print cartridge of claim 9 wherein said first and second lobes each define a substantially spherical region.

13. The print cartridge of claim 11 wherein said groove is substantially cylindrical in shape and said partline extends around a circumference of said cylindrical shaped groove.

14. A method of sealing a fluid cartridge aperture, comprising:
placing two mold halves together along a line of contact that defines a recessed region between said mold halves.

15. The method of claim 14 further comprising:
filling said mold halves with seal material to define a seal, wherein said line of contact of said two mold halves defines a partline positioned within a recessed groove of said seal.

16. The method of claim 15 further comprising:
placing said seal within an aperture of a fluid cartridge wherein said seal contacts an inner wall of said aperture in first and second sealing regions, and wherein said partline of said seal is positioned between said first and second sealing regions and out of contact with said inner wall.

17. The method of claim 14 wherein said seal defines first and second substantially spherical sealing regions and wherein said recessed groove is positioned therebetween.

18. The method of claim 14 wherein said seal is manufactured of rubber.

19. The method of claim 14 wherein said aperture is chosen from one of a fluid fill port, a leak test port, a gas exhaust port, and a flush port.

20. The method of claim 16 wherein said placing comprises press fitting said seal into said aperture.

21. The method of claim 16 wherein said seal is symmetrical and wherein said placing comprises first placing one of a first sealing end region and a second sealing end region into said aperture.

22. A fluid cartridge, comprising:
an aperture; and
sealing means positioned within said aperture, said sealing means including two separate sealing sections and a recessed part line positioned therebetween.

23. The fluid cartridge of claim 22 wherein said two separate sealing sections each extend outwardly from said sealing means.

24. The fluid cartridge of claim 22 wherein said two separate sealing sections each define a greatest outside circumference of said sealing means.

25. The fluid cartridge of claim 22 wherein said cartridge contains ink therein.

26. The fluid cartridge of claim 22 wherein said fluid cartridge is housed within an imaging device.

27. The fluid cartridge of claim 22 wherein said two separate sealing sections define redundant seals within said aperture.
